(19) United States
(12) Patent Application Publication
(10) Pub. No.: US 2010/0322845 A1
(43) Pub. Date: Dec. 23, 2010

(54) Method of Hydrogen Purification

(75) Inventor: Guillaume De Souza, Issy Les Moulineaux (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L'Exploitation Des Procedes Georges Claude, Paris (FR)

(21) Appl. No.: 12/376,462

(22) PCT Filed: Aug. 3, 2007
(86) PCT No.: PCT/FR2007/051775

§ 371 Date: Jun. 21, 2010

(30) Foreign Application Priority Data
Aug. 9, 2006 (FR) 0653329

(51) Int. Cl. C01B 3/02; B01D 53/22

(52) U.S. Cl. 423/648.1; 96/4

(57) ABSTRACT

The inventive method of gaseous hydrogen purification from a gaseous mixture comprises purifying hydrogen from a permeate gas enriched with compressed hydrogen by pressure modulation (PSA) in which one or more adsorbers are used that each follow a cycle at intervals with an adsorption phase at a high cycle pressure and a regeneration phase, producing two regeneration flows; a first recycled regeneration flow and a second non-recycled regeneration flow, characterized by the fact that the recycled regeneration flow exiting the adsorber(s) is recycled, directly or indirectly, by a sole compressor, without intermediate compression so that the sole compressor ensures both the compression of the hydrogen-enriched permeate and compression of the recycled regeneration gas.

The present invention relates to a novel method for purifying hydrogen from a gaseous mixture containing a relatively low hydrogen fraction, and to a plant for implementing such a method.

With a view toward sustainable development and given the diminishing reserves of fossil fuels, hydrogen is without a doubt going to play an increasingly important part as a “clean” fuel in the coming decades as the combustion of hydrogen generates only water and therefore does not contribute to the greenhouse effect.

However, storing and transporting pure hydrogen in a form that is compressed or liquefied through cooling, present significant safety and cost problems. Thus has emerged the idea of using existing gas transport networks such as natural gas pipelines and mains, to convey the hydrogen, at lower cost and with a lower safety risk, to hydrogen consuming equipment such as fixed fuel cells or filling stations for vehicles running on fuel cells, hydrogen turbines, or heat engines designed to burn hydrogen. The idea of mixing natural gas with a certain percentage of hydrogen, of conveying the hydrogen-enriched gaseous mixture through the natural gas pipeline system and of extracting the hydrogen from the mixture at the actual site where it is to be used has been envisioned.

In most countries, the conceivable hydrogen content that can be transported in this way using the already-existing natural gas pipeline system does not, however, exceed 10 to 20%. This is because, since hydrogen has a heat capacity significantly lower than that of natural gas, its presence reduces the overall heat capacity of the fuel mixture (natural gas+hydrogen) which, when the hydrogen content exceeds a certain level, becomes unusable in most combustion devices (burners) which have been designed to run on natural gas. This then raises the problem of finding a system capable effectively of extracting hydrogen from a gaseous mixture in which it is present at relatively low contents generally not exceeding 10 to 20%.

Of the various hydrogen purification systems which are known and currently in use, none is capable in a single purification step and at a satisfactory yield, of producing pure hydrogen from a gaseous mixture containing less than 20% hydrogen:

Selective permeation membranes are capable of separating hydrogen from a gaseous mixture through the preferential permeation of this gas by comparison with others. The driving force for this selected permeation is the partial pressure differential across the membrane. The purity of the hydrogen obtained is dependent on the selectivity of the filter material and of the membrane surface used per unit volume of gas to be purified. In spite of the high selectivities of the materials currently available, which are of the order of 225 (H₂/CH₄) in the case of a membrane made of the polyaramide MEDAL®, it is currently impossible, at an acceptable cost and in just one filtration step, to achieve the desired levels of purity, in excess of 99%, starting out with a gaseous mixture containing of the order of 10 to 20% hydrogen.

For gas separation operations in which a single stage membrane system is unable to yield a sufficiently pure gaseous product, multiple-stage membrane systems have been proposed. U.S. Pat. No. 4,264,338 for example discloses a hydrogen purification system using two-stage membrane filtration in which the permeate, enriched by having passed through a first membrane, is sent after compression to a second membrane. That document does, however, mention that a two-stage system such as this is incapable of yielding a sufficiently pure product. That document also emphasizes that the use of an additional membrane filtration stage would entail an increase in the investment and running costs of the system, these being associated in particular with the need for an additional compressor, thus making it economically unlivable.

Another hydrogen purification technique in widespread use is pressure swing adsorption (PSA). This technique is able to produce practically pure hydrogen (of a purity in excess of 99.9%) under pressure from a gaseous mixture with a relatively high hydrogen content, generally greater than about 50%.

Combining membrane filtration with pressure swing adsorption (PSA) has already been proposed in U.S. Pat. No. 4,690,695. In the gas separation method disclosed in that document, a first gaseous mixture which, in relative terms, is hydrogen lean, is first of all hydrogen-enriched by a first selective membrane filtration step. The permeate obtained, at low pressure, is then compressed using a first compressor, and sent to a PSA device which at its outlet produces better than 99.9% pure hydrogen. Some of the regeneration gas leaving the PSA device is recirculated, following a second compression step using a second compressor, to the initial membrane filtration step. The system described in that document therefore requires at least two compressors, the first compressing the permeate leaving the membrane filtration step before it enters the PSA device, and the second being used to compress the regeneration gases before they are recirculated to the membrane filtration step. The authors of that document admittedly envision an alternative form of the method whereby the first compressor is absent and the permeate, obtained at a pressure which in relative terms is higher than in the two-compressor method, is sent directly to the PSA device with no intermediate compression. That document does, however, emphasize that, in a combined system such as this with no intermediate compression, the efficiency of the membrane filtration step is considerably reduced as a result of the reduction in the partial pressure differential of the gas that is to be purified.

The objective of the present invention has been to improve a combined hydrogen purification system like the one described in U.S. Pat. No. 4,690,695 using the combination of a membrane filtration step and of a PSA step, and planning to recirculate at least one of the two regeneration streams discharged by the PSA device.

According to one option, the PSA step involves the use of PSA, at a higher regeneration pressure, generating two regeneration streams with different contents, in which at least one of the two regeneration streams is recirculated to the purification system.

The planned improvement consists in eliminating the need for at least two compressors and in succeeding in operating a combined system such as this using just one compressor without thereby reducing the efficiency of the membrane filtration step, or in other words without reducing the hydrogen partial pressure differential across the membrane.

This objective is achieved by virtue of a hydrogen purification method in which just one compressor both compresses the hydrogen-enriched permeate between the membrane filtration step and the PSA step and compresses the regeneration gas leaving the PSA device before being recirculated. The single compressor both compresses the hydrogen-enriched permeate and compresses one of the two regeneration streams leaving the PSA device before it is recirculated. In the method of the present invention, the regeneration gas is recirculated not, as in U.S. Pat. No. 4,690,695, by mixing it with the initial gaseous charge upstream of the filtration step, but either by reintroducing it directly into the PSA device or alternatively by using one of the two regeneration streams as a tangential sweep gas in the membrane filtration step.

The subject of the present invention is therefore a method of purifying gaseous hydrogen from a gaseous mixture, said method comprising

(a) a gaseous-mixture hydrogen-enrichment step involving passing said mixture, at a high pressure P1, through a selective permeation membrane, said step yielding a hydrogen-enriched gaseous permeate at low pressure P2 and a hydrogen-lean retentate at a pressure essentially equal to P1,
(b) using a compressor C to compress the hydrogen-enriched gaseous permeate from step (a) to a high pressure P3,
(c) a hydrogen-purification step purifying hydrogen from the compressed hydrogen-enriched gaseous permeate, from step (d) using a pressure swing adsorption (PSA) method, in which use is made of one or more adsorbers each of which, with a phase shift, follows a cycle involving the following in succession: (i) an adsorption phase at the cycle high pressure, essentially equal to P3, and (ii) a regeneration phase, producing two regeneration streams: a recirculated first regeneration stream and a second regeneration stream that is not recirculated,
characterized in that one of the two regeneration streams leaving the adsorber or adsorbers in the regeneration phase is returned directly or indirectly to the step (b) compressor C, is compressed to the pressure P3 and is then recirculated to the adsorber or adsorbers, the recirculated regeneration stream being returned to the step (b) compressor C with no intermediate compression such that just one compressor C both compresses the hydrogen-enriched permeate from step (a) and compresses the recirculated regeneration gas leaving the pressure swing adsorption (PSA) hydrogen purification step (c).

According to one possible specific feature, during the purification step (c) there may also be purification of an external second charge using the pressure swing absorption (PSA) method.

Although the method of the present invention can in theory be used to purify hydrogen from a gaseous mixture with any hydrogen content, it is of particular use with gaseous mixtures containing less than 30 vol %, preferably less than 20 vol % hydrogen, and in particular less than 10 vol % hydrogen. This is particularly advantageously natural gas that has been previously hydrogen-enriched, having a hydrogen content less than or equal to 30 vol %, preferably less than or equal to 20 vol %, and in particular less than or equal to 10 vol %.

Step (a) of hydrogen-enrichment of the gaseous mixture may in theory be performed with any type of gas separation membrane that exhibits sufficient selectivity toward hydrogen by comparison with the other components of the gaseous mixture. By way of example, mention may be made of the polyaramid or polyimide membranes marketed by the Applicant Company under the trade name MEDAL®. These membranes generally have the form of hollow fibers bundled in parallel into modules containing several hundred fibers. However, it is also possible to conceive of the use of membranes of spiral-wound design, in which flat sheet membranes and various dividers and intermediate drains are spiral wound around a central collecting tube. These spiral-wound membranes do not generally exhibit such good performance as membranes of the hollow fiber type.

Ceramic hydrogen purification membranes such as those described for example in patent application US 2005/0252853 could also be used as a replacement for the polyaramid or polyimide polymer membranes.

As explained in the introduction, the efficiency of the first step of hydrogen enrichment of the gaseous mixture depends first and foremost on the hydrogen partial pressure differential across the membrane. The inlet pressure at which the gaseous mixture enters the membrane filtration device is therefore advantageously as high as possible and restricted in magnitude only by the mechanical strength of the membrane used. As a preference, the pressure P1 of the gaseous mixture entering the enrichment step (a) ranges between 15 and 120 bar, preferably between 30 and 80 bar.

For the same reasons, the pressure of the hydrogen-enriched permeate, collected as it leaves the membrane, is preferably as low as possible and generally ranges between 1.5 and 6 bar, preferably between 2 and 4 bar.

Another way of increasing the hydrogen partial pressure differential across the membrane is to subject the permeate side of the membrane surface to tangential sweeping with a sweep gas that is more lean in hydrogen than the permeate. A hydrogen-lean gas such as this is available in the form of the recirculated proportion of the regeneration stream. As a result, in one particularly advantageous embodiment of the present invention, the regeneration stream leaving the adsorber or adsorber is not recirculated directly to the PSA and compression steps but is used, before being returned to the step (b) compressor C, to form a sweep gas that sweeps the surface of the membrane on the permeate side thereof, tangentially.

This embodiment will be described in greater detail hereinafter with reference to FIG. 2.

When the regeneration stream leaving the PSA adsorber or adsorbers is recirculated directly to the PSA step, without being used as a sweep gas for the membrane step, it is mixed with the permeate leaving the filtration step then the mixture is compressed by the compressor C.

The compressor C used in the method of the present invention compresses at least the permeate leaving the filtration step, mixed with the sweep gas or with the regeneration gas recirculated from the PSA device, to the PSA cycle high pressure (P3). This PSA cycle high pressure preferably ranges between 20 and 60 bar. The PSA cycle low pressure (P4) advantageously ranges between 1.5 and 6 bar, preferably between 3 and 6 bar. When the PSA cycle low pressure lies in the latter range of values, the pressure of the regeneration stream that is not recirculated is approximately 2.5 to 9 bar and it is then possible for this non-recirculated part to be sent directly and without prior compression to a natural gas main which conventionally operates within this range of pressures.

The hydrogen purification method of the present invention is thus particularly well suited to extracting hydrogen from a gaseous mixture carried in a natural gas pipeline.

In the case of a centralized hydrogen purification plant for a large town for example, the gaseous mixture that is to be purified may be tapped directly from the town's natural gas pipeline at the pressure P1 of 50 bar for example. No prior compression is needed. The tapped-off gaseous mixture is fed into the hydrogen-enrichment first step (a) and the hydrogen-lean retentate leaving step (a) at a pressure essentially equal to P1 can be returned to said natural gas main without the need to compress it. The foregoing applies likewise to an individual hydrogen purification station for a town receiving natural gas at a lower pressure of 20 bar for example.

In both instances, the only gaseous discharge from the method of the present invention is the non-recirculated regeneration gas which, when recovered at a sufficiently high pressure, for example of between 3 and 6 bar, can be reinjected directly into the town's natural gas main. The method of the present invention can thus operate without using compressors other than the step (b) compressor C which is used both to compress the step (a) permeate and to compress the regeneration gas recirculation stream from the PSA step.

When there is no natural gas main available to which to return the non-recirculated regeneration stream, this stream can be used, for example, as a fuel or alternatively, it may be conceivable for it to be reintroduced into the natural gas pipeline that supplies the purification method of the present invention. In the latter instance, it is of course necessary to provide a second compressor in order to compress the non-recirculated regeneration stream to the pressure P1 of the natural gas pipeline. This additional compressor will be less expensive than in systems of the prior art because it has a higher intake pressure and a lower compression ratio, thus reducing the installed power.

Step (c) which is the purification of hydrogen by pressure swing adsorption with at least one of the two regeneration streams being recirculated is known per se and is described in detail in International application WO 03/070358 filed in the name of the Applicant Company. All the alternative forms and preferred embodiments of the method described in that document may in theory be applied to the method of the present invention.

Thus, an additional charge, known as an external charge, that does not originate from step (a), containing at least 40 vol % of hydrogen and which may, for example, originate from a reforming method, from a partial oxidation or gasification method, may also be purified using the PSA method of step (c). Thus, the PSA considered may be a PSA with two separate feed charges (an external charge and the post-compression permeate/recirculation charge) or a PSA with a single charge once an external charge has been mixed with the permeate/recirculation charge, before or after the compressor C.

The step (c) regeneration phase thus preferably involves a depressurization step depressurizing to the cycle low pressure P4 and involving a co-current depressurization substep, a step of elution at the cycle low pressure P4, and a repressurization step repressurizing to the cycle high pressure essentially equal to P3.

In one embodiment of the method of the present invention, the depressurization step depressurizing to the cycle low pressure P4 involves, after the co-current depressurization substep, another, counter-current, depressurization substep that generates a regeneration gas which, in relative terms, is more hydrogen-lean than the elution step that follows. The regeneration stream recirculated to the compressor C will be relatively rich in hydrogen and originate predominantly from one or more adsorbers in the elution step.

In other words, a counter-current depressurization regeneration step may also partially feed into the recirculated regeneration stream.

A further subject of the invention is a hydrogen purification plant capable of implementing the abovementioned purification method. This plant comprises:
a selective permeation membrane filtration module supplied with a mixture of natural gas containing hydrogen, and
a hydrogen purification device of the PSA type, located downstream of the filtration module, generating a stream of pure hydrogen and two regeneration streams, possibly with different contents,
a compressor C, located between the filtration module and the PSA device, said compressor C being used both to compress the permeate leaving the filtration module, and to compress one of the two regeneration streams leaving the PSA-type hydrogen purification device, the one (8) of the two regeneration streams leaving the PSA-type purification device (3) being recirculated via a compressor-free line (8, 11) so that the one (8) of the two regeneration streams leaving the PSA-type purification device (3) is compressed only by said compressor C (4) located between the filtration module (2) and the PSA device.

This compressor may possibly also compress an external charge at a pressure lower than P3 before sending it to the PSA.

This plant is advantageously connected to a natural gas pipeline from which it taps off the natural gas mixture containing the hydrogen that is to be purified, preferably at a pressure ranging between 15 and 120 bar. It is also preferably connected to a natural gas main, carrying natural gas at a pressure conventionally ranging between 3 and 6 bar, into which it discharges the regeneration stream leaving the PSA-type hydrogen purification device which is not recirculated to the inlet of the compressor C or to the filtration module.

For obvious reasons concerned with reducing the investment and running costs, this plant preferably operates with just the compressor C, located between the filtration module and the PSA unit and comprises no compressor other than that one.

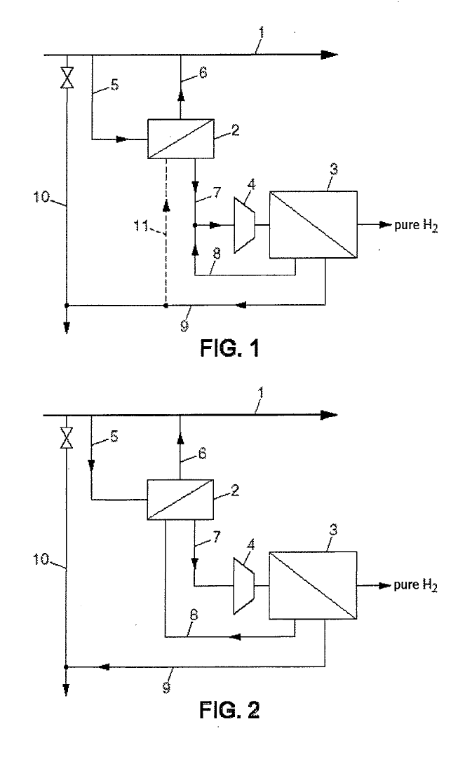

The invention is now described in greater detail with the aid of the description of two embodiments which are depicted schematically in FIGS. 1 and 2.

FIG. 1 depicts a plant for purifying hydrogen from a gaseous mixture flowing through a natural gas pipeline. The hydrogen-enriched natural gas is tapped off from the natural gas pipeline 1 using the line 5, for example at a pressure P1 of 50 bar. The natural gas is filtered in a filtration module 2 containing a plurality of selective permeation membranes. The hydrogen-lean retentate leaving the filtration module 2 essentially at a pressure equal to P1, is returned directly to the natural gas pipeline 1 by the line 6. The hydrogen-enriched permeate leaves the filtration module 2 at low pressure P2 via the line 7 and is compressed by the compressor 4 to a pressure P3 high enough for the pressure swing adsorption (PSA) step which takes place in the PSA unit 3. This PSA unit produces a stream of pure hydrogen, at a pressure essentially equal to P3, a first partial regeneration stream that is relatively rich in hydrogen, which is recirculated by the line 8 to the line 7 where it is mixed with the permeate from the filtration module 2 then compressed by the compressor 4 before being returned to the PSA unit 3, and, finally, a second partial regeneration stream that in relative terms is more lean in hydrogen than the first partial regeneration stream. This second regeneration stream leaves the PSA unit 3 via the line 9 at a high enough pressure, of the order of 3 to 6 bar, that it can be injected without additional compression into the town's natural gas main 10.

In an alternative form of embodiment of the plant, which is depicted in FIG. 1, a line 11 taps off some of the non-recirculated regeneration stream that is intended to be sent via the line 9 to the natural gas main 10. This tapped-off proportion is sent to the filtration module 2 where it is used to create a tangential sweep gas swept across the permeate-side surface of the selective permeation membranes. In order for this embodiment to be able to work correctly, it is recommended that the PSA unit be operated in such a way that the regeneration stream 9 has a PSA outlet pressure higher than the PSA outlet pressure of the regeneration stream 8. This difference in pressure is needed to compensate for the pressure drop between the pressure of the line 11 at the inlet to the filtration module 2 and the pressure of the permeate 7 at the outlet from the filtration module 2, equal to the pressure of the generation stream 8. The difference in pressure between the lines 8 and 9 is preferably equal to the pressure drop caused by the passage of the stream 11, by way of a sweep gas, through the filtration module.

FIG. 2 depicts another embodiment of the method of the present invention which is identical to that depicted in FIG. 1 except that the first regeneration stream leaving the PSA unit 3 via the line 8 is not immediately mixed with the permeate leaving the filtration module 2 to be compressed and returned to the PSA unit, but is first of all recirculated to the filtration module 2 where it is used to create a sweep gas sweeping tangentially across the permeate-side surface of the selective permeation membranes of the filtration module 2. Given that the first partial regeneration stream has a hydrogen content lower than that of the permeate, this alternative form of recirculation increases the hydrogen partial pressure differential across the selective permeation membrane and thus improves the efficiency of this filtration step.

The present invention is now illustrated using two application examples corresponding respectively to the embodiments depicted in FIGS. 1 and 2.

### EXAMPLE 1

This example illustrates a method of purifying hydrogen from a natural gas pipeline carrying a mixture of natural gas and of hydrogen (10 vol %) at a pressure of 50 bar with a proportion of the regeneration stream from the PSA unit recirculated directly.

The plant comprises 346 MEDAL® polyaramid hollow-fiber 12-inch modules, a 3.3 megawatt compressor and a PSA unit comprising 6 adsorbers each measuring approximately 28.4 m³.

Table 1 below shows the physico-chemical properties of the H₂-enriched natural gas that is to be purified, of the H₂-lean retentate obtained at the outlet from the filtration module and of the H₂-enriched permeate.

TABLE 1

| | H₂-enriched | | |
|---|---|---|---|
| | natural gas | H₂-lean | H₂-enriched |
| | to be purified | retentate | permeate |
| T(° C.) | 70 | 70.01 | 70.01 |
| P (bar abs.) | 50 | 49.77 | 4.00 |
| Q (Sm³/h) | 912804 | 879429 | 33375 |
| Q (kg/h) | 677721 | 668210 | 9511 |
| H₂ | 10.00% | 7.4% | 78.9% |
| CH₄ | 79.4% | 81.8% | 15.3% |
| C₂ | 4.0% | 4.1% | 0.5% |
| C₃ | 2.0% | 2.1% | 0.2% |
| C₄ | 0.4% | 0.4% | 0.0% |
| N₂ | 2.9% | 3.0% | 0.9% |
| CO₂ | 1.3% | 1.2% | 4.1% |

The outlet side of the membrane filtration module thus yields a hydrogen-lean (7.4%) retentate the pressure of which is essentially equal to that of the gaseous mixture tapped from the natural gas pipeline, and a highly hydrogen-enriched (78.9%) permeate at a low pressure (4 bar).

This permeate is then mixed with the recirculated portion of the regeneration stream from the PSA unit, the mixture is compressed by the compressor to a pressure of 21 bar, and is sent to the PSA unit in order to obtain a stream of pure hydrogen.

Table 2 shows the physico-chemical properties of the various gaseous streams involved in this second step of the method of the invention:
(a) the permeate leaving the filtration unit
(b) the regeneration stream recirculated from the PSA unit
(c) the mixture of (a) and (b) after compression
(d) the non-recirculated regeneration stream
(e) the stream of pure hydrogen

TABLE 2

| | (a) | (b) | (c) | (d) | (e) |
|---|---|---|---|---|---|
| T(° C.) | 30 | 30 | 30 | 25 | 35 |
| P (bar abs.) | 4 | 4 | 21 | 4 | 20 |
| Q (Sm³/h) | 33375 | 11833 | 45207 | 10061 | 23314 |
| Q (kg/h) | 9511 | 4600 | 14111 | 7436 | 2075 |
| H₂ | 78.9% | 59.32% | 73.8% | 30.0% | 100% |
| CH₄ | 15.3% | 35.57% | 20.6% | 50.8% | 0.0% |
| C₂ | 0.5% | 0.36% | 0.5% | 1.8% | 0.0% |
| C₃ | 0.2% | 0.23% | 0.2% | 0.8% | 0.0% |
| C₄ | 0.0% | 0.06% | 0.1% | 0.2% | 0.0% |
| N₂ | 0.9% | 2.29% | 1.2% | 2.9% | 0.0% |
| CO₂ | 4.1% | 2.17% | 3.6% | 13.6% | 0.0% |

This then yields a stream of pure hydrogen (e) at 2075 kg/h at a pressure of 20 bar. The non-recirculated regeneration stream (d) is at a pressure of 4 bar that is high enough to allow it to be reinjected into the natural gas main. The overall hydrogen yield of the method is 25.5%. The cost of the separation in terms of energy is equal to 4.6% of the calorific value of the purified hydrogen if the reduction in pressure between the initial gas (at 50 bar) and the gas produced (at 20 bar) is disregarded. However, even if this drop in pressure is taken into consideration, the cost of the separation in terms of energy does not exceed 7.8% of the calorific value of the hydrogen, this being a value that is highly attractive.

### EXAMPLE 2

This example illustrates a method of purifying hydrogen from a natural gas pipeline carrying a mixture of natural gas and of hydrogen (10 vol %) at a pressure of 50 bar, with part of the regeneration stream used as a sweep gas to sweep the permeate side of the separation membrane.

The plant comprises 200 MEDAL® polyaramid hollow-fiber 12-inch modules, a 4.1 megawatt compressor and a PSA unit comprising 6 adsorbers each measuring approximately 27.1 m³.

Table 3 below shows the physico-chemical properties of the various gaseous streams involved in this membrane filtration step, namely:

(a) natural gas/H₂ to be purified
(b) H₂-lean retentate
(c) sweep gas (regeneration stream from the PSA unit)
(d) permeate leaving the filtration module (mixture of the diffusion permeate (79.9% H₂) and of the sweep gas

TABLE 3

| | (a) | (b) | (c) | (d) |
|---|---|---|---|---|
| T(° C.) | 70 | 70 | 70 | 70 |
| P(bar abs.) | 50 | 49.65 | 4.23 | 2.45 |
| Q (Sm³/h) | 1198326 | 1132582 | 11128 | 44000 |
| Q (kg/h) | 889710 | 871862 | 4030 | 12954 |
| H₂ | 10.00% | 5.9% | 62.88% | 75.59% |
| CH₄ | 79.4% | 83.14% | 32.60% | 19.39% |
| C₂ | 4.0% | 4.2% | 0.33% | 0.48% |
| C₃ | 2.0% | 2.1% | 0.22% | 0.24% |
| C₄ | 0.4% | 0.42% | 0.06% | 0.05% |
| N₂ | 2.9% | 3.02% | 2.09% | 1.16% |
| CO₂ | 1.3% | 1.17% | 1.83% | 3.09% |

The permeate (d) leaving the filtration module is at a pressure of 2.45 bar, which is lower than the pressure of the permeate in example 1, and has a hydrogen content of 75.6%, which is lower than that of the permeate of example 1. The ensuing reduction in the hydrogen partial pressure results in better efficiency of this filtration step.

The permeate (d) is compressed and then sent to the PSA unit. Table 4 below shows the physico-chemical properties of the various streams involved in this PSA step, namely

(a) compressed permeate before it enters the PSA unit
(b) recirculated regeneration stream (sweep gas)
(c) non-recirculated regeneration stream
(d) stream of pure hydrogen

TABLE 4

| | (a) | (b) | (c) | (d) |
|---|---|---|---|---|
| T(° C.) | 30 | 30 | 25 | 35 |
| P(bar abs.) | 21 | 2.45 | 4 | 20 |
| Q (Sm³/h) | 44000 | 11127 | 9625 | 23248 |
| Q (kg/h) | 12954 | 4013 | 6873 | 2069 |
| H₂ | 75.6% | 62.90% | 31.3% | 100% |
| CH₄ | 19.4% | 32.58% | 51.0% | 0% |
| C₂ | 0.5% | 0.33% | 1.8% | 0% |
| C₃ | 0.2% | 0.22% | 0.8% | 0% |
| C₄ | 0.0% | 0.06% | 0.2% | 0% |
| N₂ | 1.2% | 2.08% | 2.9% | 0% |
| CO₂ | 3.1% | 1.84% | 12.0% | 0% |

This then yields a stream of pure hydrogen at 2069 kg/h at a pressure of 20 bar. The non-recirculated regeneration stream (c) is at a pressure of 4 bar which is high enough to allow it to be reinjected into the natural gas main. The overall hydrogen yield of the method is 38.8%. The cost of the separation in terms of energy is equal to 5.9% of the calorific value of the purified hydrogen if the reduction in pressure between the initial gas (at 50 bar) and the gas produced (at 20 bar) is disregarded. However, even taking this drop in pressure into consideration, the cost of the separation in terms of energy does not exceed about 9% of the calorific value of the hydrogen, which is a value which is entirely acceptable and similar to that of example 1. However, achieving these results required just 200 filtration modules as compared with the 346 modules used in example 1.

1. A method of purifying gaseous hydrogen from a gaseous mixture, said method comprising
(a) a gaseous-mixture hydrogen-enrichment step involving passing said mixture, at a high pressure P1, through a selective permeation membrane, said step yielding a hydrogen-enriched gaseous permeate at low pressure P2 and a hydrogen-lean retentate at a pressure essentially equal to P1,
(b) using a compressor C to compress the hydrogen-enriched gaseous permeate from step (a) to a high pressure P3,
(c) a hydrogen-purification step purifying hydrogen from the compressed hydrogen-enriched gaseous permeate, using a pressure swing adsorption (PSA) method, in which use is made of one or more adsorbers each of which, with a phase shift, follows a cycle involving the following in succession: an adsorption phase at the cycle high pressure, essentially equal to P3, and a regeneration phase, producing two regeneration streams: a recirculated first regeneration stream and a second regeneration stream that is not recirculated,
characterized in that the recirculated regeneration stream leaving the adsorber or adsorbers in the regeneration phase is returned directly or indirectly to the step (b) compressor C, is compressed to the pressure P3 and is then recirculated to the adsorber or adsorbers, the recirculated regeneration stream being returned to the step (b) compressor C with no intermediate compression such that just one compressor C both compresses the hydrogen-enriched permeate from step (a) and compresses the recirculated regeneration gas leaving the pressure swing adsorption (PSA) hydrogen purification step (c).

2. The hydrogen purification method as claimed in claim 1, characterized in that the recirculated regeneration stream, before being returned to the step (b) compressor C, is used to form a sweep gas that sweeps the surface of the membrane on the permeate side thereof, tangentially.

3. The hydrogen purification method as claimed in claim 1 or 2, characterized in that part of the non-recirculated regeneration stream is tapped off and sent to the filtration module where it is used to create a sweep gas that sweeps the surface of the permeate side of the selective permeation membranes tangentially.

4. The method as claimed in any one of claims 1 to 3, characterized in that the first partial stream of recirculated regeneration gas is, in relative terms, richer in hydrogen than the second partial stream of non-recirculated regeneration gas (or residual gas).

5. The method as claimed in claim 4, characterized in that the step (c) regeneration phase involves a depressurization step depressurizing to a low pressure P4 of the cycle involving a first, co-current, depressurization substep, an elution step at the cycle low pressure P4, and a repressurization step repressurizing to the cycle high pressure essentially equal to P3, the step of depressurizing to the cycle low pressure P4 involving, after the co-current first depressurization substep, a countercurrent second depressurization substep that generates a regeneration gas which, in relative terms, is more lean in hydrogen than the elution step that follows, the regeneration stream recirculated to the compressor C being relatively hydrogen-rich and originating predominantly from one or more adsorbers in the elution step.

6. The hydrogen purification method as claimed in one of the preceding claims, characterized in that the step (c) regeneration phase involves a depressurization step depressurizing to a cycle low pressure P4 and involving a co-current depressurization sub-step, an elution step at the cycle low pressure P4, and a repressurization step repressurizing to the cycle high pressure, essentially equal to P3.

7. The hydrogen purification method as claimed in any one of the preceding claims, characterized in that the pressure P1 of the gaseous mixture entering the enrichment step (a) ranges between 15 and 120 bar, preferably between 30 and 80 bar.

8. The hydrogen purification method as claimed in any one of the preceding claims, characterized in that the pressure P2 of the hydrogen permeate, collected as it leaves the membrane, ranges between 1.5 and 6 bar, preferably between 2 and 4 bar.

9. The hydrogen purification method as claimed in any one of the preceding claims, characterized in that the gaseous mixture entering the enrichment step (a) is natural gas that has been previously hydrogen-enriched, having a hydrogen content less than or equal to 30 vol %, preferably less than or equal to 20 vol %, and in particular less than or equal to 10 vol %.

10. The hydrogen purification method as claimed in any one of the preceding claims, characterized in that the PSA cycle high pressure, essentially equal to P3, ranges between 20 and 60 bar.

11. The hydrogen purification method as claimed in any one of the preceding claims, characterized in that the PSA cycle low pressure P4 ranges between 1.5 and 6 bar, preferably between 3 and 6 bar.

12. The hydrogen purification method as claimed in any one of the preceding claims, characterized in that the gaseous mixture that is to be purified is tapped from a natural gas pipeline at the pressure P1 and in that the hydrogen-lean retentate leaving step (a) at a pressure essentially equal to P1 is returned to said natural gas pipeline.

13. The hydrogen purification method as claimed in any one of the preceding claims, characterized in that the non-recirculated regeneration stream leaving the adsorber or absorbers in the regeneration phase is sent to a natural gas main at a pressure ranging between 2.5 and 9 bar, preferably between 3 and 6 bar.

14. A hydrogen purification method as claimed in any one of the preceding claims, characterized in that it uses no compressors other than the step (b) compressor C.

15. A hydrogen purification plant comprising
a selective permeation membrane filtration module (2) supplied with a mixture of natural gas containing hydrogen, and
a hydrogen purification device of the PSA type (3), located downstream of the filtration module (2), generating a stream of pure hydrogen and two regeneration streams,
a compressor C (4), located between the filtration module (2) and the PSA device, said compressor C being used both (i) to compress the permeate leaving the filtration module (2), and (ii) to compress one (8) of the two regeneration streams leaving the PSA-type hydrogen purification device (3), the one (8) of the two regeneration streams leaving the PSA-type purification device (3) being recirculated via a compressor-free line (8, 11) so that the one (8) of the two regeneration streams leaving the PSA-type purification device (3) is compressed only by said compressor C (4) located between the filtration module (2) and the PSA device.

16. The hydrogen purification plant as claimed in claim 15, characterized in that it is connected to a natural gas pipeline (1) from which it taps off the mixture of natural gas containing hydrogen, and to a natural gas main (10) to which it discharges one (9) of the two regeneration streams leaving the PSA-type hydrogen purification device (3).

17. The hydrogen purification plant as claimed in claim 15 or 16, characterized in that it comprises no compressor other than the compressor C (4).

18. The hydrogen purification plant as claimed in any one of claims 15 to 17, characterized in that an external charge may be sent to the PSA inlet to supplement the permeate and recirculated gas, with or without compression by the compressor C, in order to allow additional hydrogen production.
